(19) United States
(12) Patent Application Publication
(10) Pub. No.: US 2006/0078085 A1
(43) Pub. Date: Apr. 13, 2006

(54) Stereoscopic x-ray imaging apparatus for obtaining three dimensional coordinates

(75) Inventor: Johannes Martin Zanker, Glenholme (GB)

Correspondence Address: THE MAXHAM FIRM, 750 "B" STREET, SUITE 3100, SAN DIEGO, CA, 92101, US

(73) Assignee: ROYAL HOLLOWAY & BEDFORD NEW COLLEGE A UNIVERSITY, Surrey TW20 0EX (GB)

(21) Appl. No.: 10/518,189

(22) PCT Filed: Jun. 13, 2003
(86) PCT No.: PCT/GB03/02572

§ 371 Date: Aug. 25, 2005

(30) Foreign Application Priority Data
Jun. 17, 2002 (GB) 0213951.7

(51) Int. Cl. G01N 23/04

(52) U.S. Cl. 378/57

(57) ABSTRACT

A screening device for use in scanning objects for security checking or medical observation includes an X-ray source providing two beams for projection at the object, a linear sensor array being provided for each beam whereby an intensity map and a motion map is generated to provide a data set from which a 3D image can be generated and viewed.

### BACKGROUND OF THE INVENTION

1. Field of the Invention

This invention concerns improvements in or relating to screening apparatus and in particular although not exclusively has reference to security screening apparatus.

2. Discussion of Related Art

It is well known to scan people and objects non-intrusively to ascertain their interior structures or contents and to identify areas of potential hazard or danger in either the medical or security sense.

Conventionally, X-ray equipment has successfully been used for these purposes, but in recent years there has become an increasing need to provide more comprehensive, in particular three-dimensional images than those provided by the two-dimensional X-ray. For example, in the medical field CT scanning has been introduced to provide detailed mapping of various parts of the body on an intensive basis, namely by providing cross-sectional images. However, such scanning procedures involve the use of very costly equipment and are extremely expensive to operate.

In the security field the adoption of CT scanning is clearly an option but its cost implications render it an unlikely candidate for adoption.

One of the problems attendant upon conventional X-ray security scanning is its limitation in terms of being unable per se to provide detailed imaging of baggage contents particularly when they are stacked for example in a suitcase since they are superimposed one on the other and the images are thus occluded.

One previous attempt to provide a security scanning device using X-ray technology is that taught by Robinson in European Patent Application 0 261 984 in which he proposes a binocular stereoscopic X-ray inspection system. His system involves the inspection of objects passing successively under two X-ray beams, and over two respective line-array detectors upon which the beams fall. The two beams are set at an angle to one another in the plane parallel to the path of movement so as to capture left and right perspective views of each object on the line-scan principle. The views are stored in respective frame stores the video information from which they are displayed stereoscopically on a special monitor. This procedure, however, requires the use of electro-optic viewing spectacles which are controlled by the video system. Accordingly the 3D image is generated essentially by the operator rather than by the scanning equipment as such.

### SUMMARY OF THE INVENTION

It is an object of the present invention to provide an improved method of scanning and a scanning device therefor which affords a 3D image viewing capability in the absence of any special interactive equipment dedicated to use by the operator and independent of the perceptual system of the operator creating the depth information.

According to a first aspect of the present invention there is provided a method of scanning including the steps of projecting two X-ray beams towards a moving or static object, sensing the images generated from the X-ray beams, detecting two spatial dimensions from the images, developing motion and intensity maps from the two spatial dimensions thereby to generate by the use of algorithms the third spatial dimension and to provide a data set for the construction of a 3D image for display on a viewing monitor.

In the case of static images generated by two line scanners, the disparity map for the intensity maps is calculated from two parallel detector arrays and converted into depth coordinates using conventional stereo-algorithms and the fixed geometry of the equipment, giving two image arrays representing views from different angles. Trucco & Verri 1998, Introductory Techniques for 3D Computer Vision, Prentice Hall Publications, New Jersey provide some software solutions for stereo vision in this context.

In the case of a moving object, for example being carried by a conveyor belt, due to the motion of the objects on the conveyor belt, the disparity information can be replaced by time delay information. In one embodiment of the present invention the method includes the steps of developing the third spatial dimension from moving representations of the flat screened object by calculating motion parallax maps for the intensity map which can be converted into depth coordinates using the fixed geometry of the conveyor belt or calibration markers on the belt.

In both cases the data set is generated and comprises 3D-coordinates for all visible object contours from which parallel projections in the three cardinal directions can be constructed. In a further development software may be provided to allow real-time rotation of the 3D data set to permit continuous manipulation of the viewing angle by the operator.

Algorithms may be incorporated in the computer software to allow the 3D images of the scanned object stored in the computer memory to be transferred into projection images, such as top, side, or front elevations using trigonometric transformations such for example as Euler transformations. The same algorithms allow the adoption of any viewing angle, controlled by the operator, for instance by means of a joystick, the two degrees of freedom of the joystick determining the elevation and azimuth of the viewing perspective, namely of the projection plane. Proprietary polygonal object modelling and rendering techniques may additionally be used to enhance visualisation. For example those disclosed by Foley et al ‘Computer Graphics, Principles and Practice’, Addison Wesley, 1997.

According to a second aspect of the present invention there is provided a X-ray scanning device for a static or moving object including an X-ray source providing two or more X-ray beams, and a sensor array provided for each beam, the arrays being displaced spatially one from the other, the arrays being adapted to generate two two-dimensional images, a computer incorporating software adapted to calculate a third, depth dimension thereby to create a 3D image of the object, and a monitor for displaying the 3D image.

The scanning device may incorporate a conveyor belt for carrying the object for scrutiny and the sensor arrays are spatially disposed to capture two images of the moving object to generate an intensity map and a motion map.

The conveyor belt may be provided with calibration markers to provide a self-calibrating system.

### BRIEF DESCRIPTION OF THE DRAWING

By way of example only one method of scanning an object and a device therefor according to the invention are described below with reference to the accompanying drawings in which:

FIG. 1 is a schematic diagram of the device; and

FIG. 2 is a sketch showing the geometric analysis of the method.

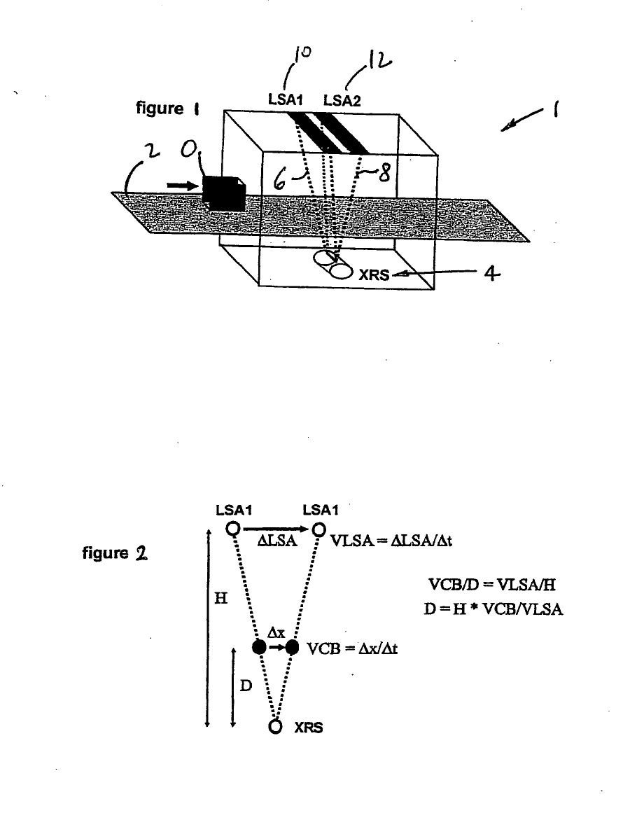

### DETAILED DESCRIPTION OF THE PREFERRED EMBODIMENTS

Referring to the drawings, there is provided an X-ray scanning device 1 employed for the security scanning of baggage, the device being associated with a conveyor belt 2 beneath which is disposed an X-ray source 4 for projecting two non-parallel X-ray beams 6, 8 upwardly through the belt 2, the angle between the beams 6, 8 determining the quality of 3D reconstruction.

A linear sensor array 10, 12 designated LSA1 and LSA2 is provided above the belt for sensing each of the beams 6, 8 respectively, the arrays being spatially separated one from the other.

The time that the projection of an object O needs to be shifted from LSA1 to LSA2, At depends on the perpendicular distance D between the X-ray source 4, XRS, and the object.

In use an object O is carried on the conveyor belt 2 and is subjected to the X-ray beams 6, 8. The object O is travelling with the speed of the conveyor belt VCB across a distance Δx in a time interval Δt, determined by VCB=Δx/Δt. The projection of O on the image plane defined by the two sensor arrays LSA1 and LSA2, in the same time interval Δt travels across the distance ΔLSA, leading to an image speed VLSA=ΔLSA/Δt. Similar triangles relate the object distance from XRS, X-ray source 4, D, and the height of the sensors above XRS, H, by the equations Δx/D=ΔLSA/H and VCB/D=VLSA/H. From this relationship the object distance D=H*VCB/VLSA can be derived from the known height H and conveyor belt speed VCB by measuring image speed VLSA.

By taking into account these simple geometrical relationships, depth can therefore be reconstructed from the input signals of two corresponding sensors in the line cameras, using simple motion detector algorithms that can be cheaply implemented in ID or 2D-arrays, see for example Zanker et al 1999 ‘Speed tuning in elementary motion detectors of the correlation type’ Biological Cybernetics 80, 109-116 and Zanker et al 1997 ‘A two-dimensional motion detector model (2DMD) responding to artificial and natural image sequences’ Investigative Ophthalmology and Visual Science 38, S 936. A further reference of interest is concerned with biologically motivated motion detection algorithms: recovering motion by detecting spatiotemporal correlation (Reichardt, 1961 “Autocorrelation, a principle for the evaluation of sensory information by the central nervous system”, in Sensory Communication Ed Rosenblith, pp 303-317.

The representation quality may be improved by a number of additional steps, such as using more than two input elements, or by optimising the source-sensor geometry.

It is to be understood other speed algorithms may be employed in the practice of the invention such as those commonly used in machine vision, thus for example:

Conventional machine vision approach: matching image regions by determining the displacement maximising the correlation between two image regions (Benayoun, Ayache, 1998, Dense Non-Rigid Motion Estimation in Sequences of Medical Images Using Differential Constraints, Int. J. Comp. Vision 26 25-40).

Gradient-type motion detection algorithms: recovering speed by means of filters solving the general motion equation (Srinivasan, 1990, Generalized Gradient Schemes for the Measurement of Two-Dimensional Image Motion, Biol. Cybern. 63 421-431; Johnston, McOwan, Benton, 1999, Robust velocity computation from a biologically motivated model of motion perception, Proc. R. Soc. Lond B 266 509-518).

The advantage of the present invention resides in the use of relatively cheap software rather than the more complicated and thus more expensive hardware approaches of the prior art.

A further advantage of the present invention is the construction of depth information does not rely on the perception of the operator, but is automated and thus allows for objective classification and easy communication and storage.

The present invention has a principal application in the field of security scanning as used at airports and points of entry, or in public buildings generally. However, the scanning technique and the device can also be used for medical scanning. It can also have application generally for example in scanning objects in a desktop environment to generate wire-frame models.

1. A method of scanning using X-ray equipment comprising the steps of projecting two X-ray beams towards a moving or static object, sensing the images generated from the X-ray beams, detecting two spatial dimensions from the images, developing motion and intensity maps from the two spatial dimensions thereby to generate by the use of algorithms the third spatial dimension and to provide a data set for the construction of a 3D image for display on a viewing monitor.

2. The method according to claim 1 wherein the object is carried on a conveyor belt.

3. The method according to claim 2 further comprising the step of developing the third spatial dimension from moving representations of the flat screened object by calculating motion parallax maps for the intensity map which can be converted into depth coordinates using the fixed geometry of the conveyor belt or calibration markers on the conveyor belt.

4. The method according to claim 1 wherein for two static images generated by the line scanners, the disparity map for the intensity maps is calculated from two parallel detector arrays and converted into depth coordinates using conventional stereo-algorithms and the fixed geometry of the X-ray equipment.

5. The method according to claim 1 wherein the data set is generated and comprises 3D coordinates for all visible object contours from which parallel projections in the three cardinal directions can be constructed.

6. The method according to claim 1 wherein algorithms are provided to allow real-time rotation of the 3D data set to permit continuous manipulation for the viewing angle by the operator.

7. The method according to claim 1 wherein algorithms are provided to allow the 3D images of the scanned object to be transferred into projection images.

8. The method according to claim 7 wherein the algorithms are adapted to allow the adoption of any viewing angle.

9. An X-ray scanning device for a static or moving object for use in the method according to claim 1 wherein an X-ray source providing two or more X-ray beams, and a sensor array provided for each beam, the arrays being displaced spatially one from the other, the arrays being adapted to generate two two-dimensional images, a computer incorporating software adapted to calculate a third, depth dimension thereby to create a 3D image of the object, and a monitor for displaying the 3D image.

10. The device according to claim 9 wherein the device includes a conveyor belt for carrying the object, and the sensor arrays are spatially disposed to capture two images of the moving object to generate an intensity map and a motion map.

11. The device according to claim 10 wherein the conveyor belt is provided with calibration markers to provide a self-calibrating system.

12. An X-ray scanning device for a static or moving object for use in the method according to claim 8 wherein an X-ray source providing two or more X-ray beams, and a sensor array provided for each beam, the arrays being displaced spatially one from the other, the arrays being adapted to generate two two-dimensional images, a computer incorporating software adapted to calculate a third, depth dimension thereby to create a 3D image of the object, and a monitor for displaying the 3D image.

13. The device according to claim 12 wherein the device (1) includes a conveyor belt for carrying the object, and the sensor arrays are spatially disposed to capture two images of the moving object to generate an intensity map and a motion map.

14. The device according to claim 13 wherein the conveyor belt is provided with calibration markers to provide a self-calibrating system.
